(19) United States
(12) Patent Application Publication
(10) Pub. No.: US 2023/0037892 A1
(43) Pub. Date: Feb. 9, 2023

(54) METHOD AND APPARATUS FOR GENERATING SPEECH TRAINING DATA

(71) Applicant: Xinapse Co., Ltd., Seoul (KR)

(72) Inventors: Dong Won JOO, Seoul (KR); Jinbeom KANG, Seoul (KR); Yongwook NAM, Seoul (KR); Jung Hoon LEE, Yongin-si (KR)

(21) Appl. No.: 17/814,650

(22) Filed: Jul. 25, 2022

(30) Foreign Application Priority Data
Jul. 28, 2021 (KR) 10-2021-0099514
Jul. 29, 2021 (KR) 10-2021-0100177
Jun. 23, 2022 (KR) 10-2022-0077129

(51) Int. Cl. G10L 13/047; G10L 25/60; G10L 25/18

(52) U.S. Cl. CPC G10L 13/047; G10L 25/60; G10L 25/18

(57) ABSTRACT

A computer-implemented method of generating speech training data is proposed. The method may include generating, at a processor, a recording script corresponding to particular text. The method may also include generating, at the processor, recorded data by performing recording by a speaker based on the recording script. The method may further include labeling, at the processor, the recorded data. Various embodiments can generate a large amount of speech training data for training an artificial neural network model while minimizing a worker's inconvenience and time consumption.

### CROSS-REFERENCE TO RELATED APPLICATION

This application is based on and claims priority under 35 USC § 119 to Korean Patent Application Nos. 10-2021-0099514, filed on Jul. 28, 2021, 10-2021-0100177, filed on Jul. 29, 2021, 10-2022-0077129, filed on Jun. 23, 2022 in the Korean Intellectual Property Office, the disclosure of each of which is incorporated by reference herein in its entirety.

### BACKGROUND

### Technical Field

The present disclosure relates to methods and systems for generating speech training data.

### Description of Related Technology

Recently, interfaces using speech signals have been generalized with the development of artificial intelligence technology. Accordingly, research on a speech synthesis technology that enables a synthesized speech to be uttered according to a given situation has been actively conducted.

### SUMMARY

Provided are methods and apparatuses for a speech generation technology capable of generating a large amount of speech training data for training an artificial neural network model while minimizing a worker's inconvenience and time consumption.

Provided are methods and apparatuses for a speech generation technology that does not raise a copyright issue in relation to a recording script when performing recording for speech training data.

The technical problems to be solved are not limited to the technical problems as described above, and other technical problems may be inferred.

Additional aspects will be set forth in part in the description which follows and, in part, will be apparent from the description, or may be learned by practice of the presented embodiments of the disclosure.

According to an aspect of an embodiment, a method includes: generating a recording script corresponding to particular text; generating recorded data by performing recording by a speaker based on the recording script; and labeling the recorded data.

The generating the recording script may include: receiving a plurality of sentence samples; and generating the recording script based on the plurality of sentence samples.

The generating the recorded data may include: detecting an utterance duration corresponding to a duration for which the speaker actually utters; and generating the recorded data by using the utterance duration.

The method may further include: calculating a score corresponding to the recorded data, based on the recording script and the recorded data; comparing the score with a preset value; and evaluating, according to a result of the comparison, quality of the recorded data indicating whether or not the speaker performs recording to match the recording script.

The method may further include determining whether or not to regenerate the recorded data, based on whether or not the quality of the recorded data satisfies a certain criterion.

The labeling may include performing one or more of emotion labeling and region labeling of the recorded data.

According to an aspect of another embodiment, a computer-readable recording medium includes a program for executing the above-described method in a computer.

According to an aspect of another embodiment, a system includes: at least one memory; and at least one processor operated by at least one program stored in the memory, wherein the at least one processor executes the method described above.

### BRIEF DESCRIPTION OF THE DRAWINGS

The above and other aspects, features, and advantages of certain embodiments of the disclosure will be more apparent from the following description taken in conjunction with the accompanying drawings.

FIG. 1 is a block diagram schematically illustrating an operation of a speech synthesis system.

FIG. 2 is a block diagram illustrating an embodiment of a speech synthesis system.

FIG. 3 is a block diagram illustrating an embodiment of a synthesizer of a speech synthesis system.

FIG. 4 is a diagram illustrating an embodiment of a vector space for generating an embedding vector by a speaker encoder.

FIG. 5 is a block diagram schematically illustrating an operation of a system for generating speech training data.

FIG. 6 is a block diagram illustrating an embodiment of evaluating quality of recording by using a score calculator.

FIG. 7 is a diagram illustrating an embodiment in which a synthesizer generates second spectrograms based on first spectrograms.

FIGS. 8A and 8B are diagrams illustrating quality of an attention alignment corresponding to second spectrograms.

FIG. 9 is a diagram illustrating an embodiment in which a score calculator calculates an encoder score.

FIG. 10 is a diagram illustrating an embodiment in which a score calculator calculates a decoder score.

FIG. 11 is a diagram illustrating an embodiment in which a score calculator calculates a concentration score

FIG. 12 is a diagram illustrating an embodiment in which a score calculator calculates a step score.

FIG. 13 is a flowchart illustrating an embodiment of a method of generating speech training data.

### DETAILED DESCRIPTION

The speech synthesis technology has been combined with a speech recognition technology based on artificial intelligence and applied to many fields such as virtual assistants, audiobooks, automatic interpretation and translation, and virtual voice actors.

Examples of a general speech synthesis method include various methods, such as concatenative synthesis (unit selection synthesis (USS)) and statistical parametric speech synthesis (hidden Markov model (HMM)-based speech synthesis (HTS)). The USS method refers to a method of cutting out speech data into phoneme units, storing the phoneme units, finding sound pieces appropriate for utterance during speech synthesis, and concatenating the sound pieces. The HTS method refers to a method of generating a statistical model by extracting parameters corresponding to speech characteristics, and reconstructing text into speech based on the statistical model. However, the existing speech synthesis method described above has many limitations in synthesizing natural speeches by reflecting a speaker's utterance style, emotional expression, or the like.

Accordingly, recently, a speech synthesis method of synthesizing speech from text based on an artificial neural network has attracted attention.

Meanwhile, in the speech synthesis method of synthesizing speech from text based on an artificial neural network, an artificial neural network model needs to be trained with speech data of various speakers, and thus, a large amount of speech training data is needed.

A recording script is generally directly generated, or previously known materials are selected and used to generate a large amount of speech training data, and post-processing editing is undergone to cut, into respective sentences, the entire audio file generated by reading the entire recording script by a speaker. In addition, whether or not to perform re-recording is determined by directly hearing and determining whether or not the speaker performs recording well, and, for the study of emotions, dialects, and the like, a speaker performing recording directly selects a label and then performs recording.

However, the above processes may consume, for a worker, a lot of time and cost and may be considerably inconvenient, and a copyright issue may occur with respect to a recording script. Accordingly, there is a need for a speech training data generation technology capable of minimizing unneeded consumption and work in a series of work processes, such as generation of a recording script, recording, quality evaluation, storage, and labeling, and maximizing the convenience of a speaker.

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

The terms used in the present embodiments are selected as currently widely used general terms as possible while considering the functions in the present embodiments, but may vary depending on the intention or precedent of one of ordinary skill in the art, the emergence of new technology, and the like. In addition, in certain cases, there are also terms arbitrarily selected by the applicant, and in this case, the meanings thereof will be described in detail in the relevant part. Therefore, the terms used in the present embodiments should be defined based on the meanings of the terms and the description throughout the present embodiments, rather than the simple names of the terms.

While the present embodiments are capable of various modifications and alternative forms, embodiments thereof are shown by way of example in the drawings and will herein be described in detail. It should be understood, however, that there is no intent to limit the present embodiments to the particular forms disclosed, but on the contrary, the present embodiments are to cover all modifications, equivalents, and alternatives falling within the spirit and scope of the present embodiments. The terminology used herein is for the purpose of describing particular embodiments only and is not intended to be limiting of the embodiments.

Unless otherwise defined, all terms used in the present embodiments have the same meaning as commonly understood by one of ordinary skill in the art to which the present embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

For the detailed description that will follow below, reference is made to the accompanying drawings, which show by way of illustration of particular embodiments in which the present disclosure may be implemented. These embodiments are described in sufficient detail to enable one of ordinary skill in the art to implement the present disclosure. It should be understood that various embodiments are different from one another, but need not be mutually exclusive. For example, certain shapes, structures, and characteristics described herein may be implemented with changes from one embodiment to another without departing from the spirit and scope of the present disclosure. In addition, it should be understood that the locations or arrangements of individual elements within each embodiment may be changed without departing from the spirit and scope of the present disclosure. Accordingly, the following detailed description is not to be taken in a limiting sense, and the scope of the present disclosure should be taken as encompassing the scope of claims and all equivalents thereto. In the drawings, like reference numerals refer to the same or similar elements throughout the various aspects.

Meanwhile, as described herein, technical features that are individually described within one drawing may be implemented individually or may be implemented at the same time.

As used herein, “˜unit” may be a hardware component such as a processor or a circuit, and/or a software component executed by a hardware component such as a processor. Hereinafter, various embodiments will be described in detail with reference to the accompanying drawings to enable one of ordinary skill in the art to easily practice the present disclosure.

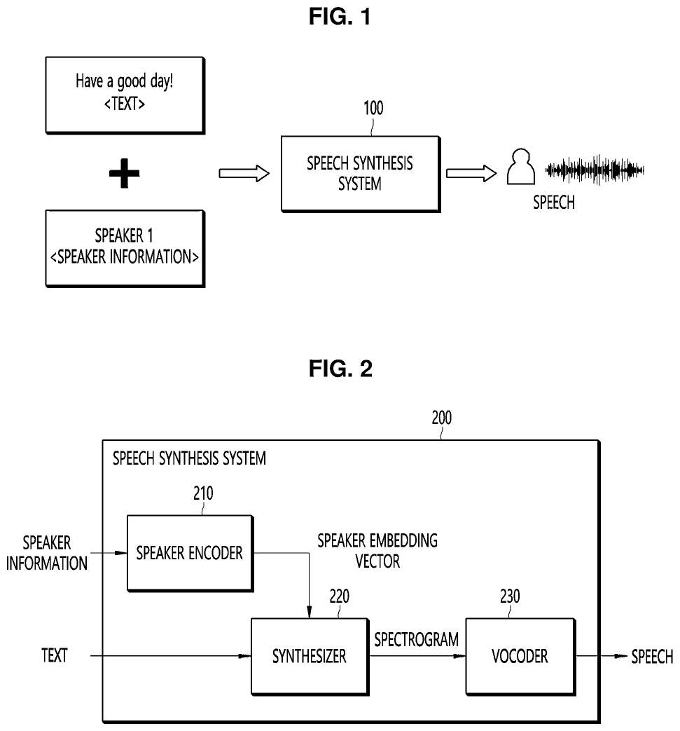

FIG. 1 is a block diagram schematically illustrating an operation of a speech synthesis system.

A speech synthesis system refers to a system that converts text into human speech.

For example, a speech synthesis system 100 of FIG. 1 may be an artificial neural network-based speech synthesis system. An artificial neural network refers to an overall model having a problem-solving ability, in which artificial neurons form a network via synaptic bonding and change the strength of synaptic bonding through learning.

The speech synthesis system 100 may be implemented as various types of devices, such as a personal computer (PC), a server device, a mobile device, and an embedded device, and, as a particular example, may correspond to a smart phone, a tablet device, an augmented reality (AR) device, an Internet of Things (IoT) device, an autonomous vehicle, robotics, a medical device, an e-book terminal, a navigation device, and the like that perform speech synthesis by using an artificial neural network, but is not limited thereto.

Furthermore, the speech synthesis system 100 may correspond to a dedicated hardware (HW) accelerator mounted on a device as described above. Alternatively, the speech synthesis system 100 may be a hardware accelerator, such as a neural processing unit (NPU), a tensor processing unit (TPU), or a neural engine, which is a dedicated module for driving an artificial neural network, but is not limited thereto.

Referring to FIG. 1, the speech synthesis system 100 may receive a text input and particular speaker information. For example, as shown in FIG. 1, the speech synthesis system 100 may receive “Have a good day!” as a text input, and may receive “speaker 1” as a speaker information input.

“Speaker 1” may correspond to a speech signal or speech sample indicating preset utterance characteristics of speaker 1. For example, speaker information may be received from an external device via a communicator included in the speech synthesis system 100. Alternatively, speaker information may be input from a user via a user interface of the speech synthesis system 100 or may be one selected from among various types of pieces of speaker information pre-stored in a database of the speech synthesis system 100, but is not limited thereto.

The speech synthesis system 100 may output speech based on the text input and the particular speaker information that are received as inputs. For example, the speech synthesis system 100 may receive, as inputs, “Have a good day!” and “speaker 1,” and may output speech for “Have a good day!”, in which the utterance characteristics of the speaker 1 are reflected. The utterance characteristics of the speaker 1 may include at least one of various factors, such as a voice, a rhyme, a pitch, and an emotion of the speaker 1. In other words, the output speech may be speech as when the speaker 1 naturally pronounces “Have a good day!”.

FIG. 2 is a block diagram illustrating an embodiment of a speech synthesis system. A speech synthesis system 200 of FIG. 2 may be the same as the speech synthesis system 100 of FIG. 1.

Referring to FIG. 2, the speech synthesis system 200 may include a speaker encoder 210, a synthesizer 220, and a vocoder 230. Meanwhile, FIG. 2 illustrates that the speech synthesis system 200 includes only elements related to an embodiment. Accordingly, it is obvious to one of ordinary skill in the art that the speech synthesis system 200 may further include other general-purpose elements, in addition to the elements illustrated in FIG. 2.

The speech synthesis system 200 of FIG. 2 may output speech by receiving speaker information and text as inputs.

For example, the speaker encoder 210 of the speech synthesis system 200 may generate a speaker embedding vector by receiving the speaker information as an input. The speaker information may correspond to a speaker's speech signal or speech sample. The speaker encoder 210 may receive the speaker's speech signal or speech sample, extract the speaker's utterance characteristics, and represent the extracted utterance characteristics as an embedding vector.

The speaker's utterance characteristics may include at least one of various factors, such as an utterance speed, a pause duration, a pitch, a tone, a rhyme, an intonation, and an emotion. In other words, the speaker encoder 210 may represent, as a vector having continuous numbers, discontinuous data values included in the speaker information. For example, the speaker encoder 210 may generate the speaker embedding vector based on at least one or a combination of two or more of various types of artificial neural networks, such as a pre-net, a CBHG module, a deep neural network (DNN), a convolutional neural network (CNN), a recurrent neural network (RNN), a long short-term memory network (LSTM), and a bidirectional recurrent deep neural network (BRDNN).

For example, the synthesizer 220 of the speech synthesis system 200 may output a spectrogram by receiving, as inputs, the text and the embedding vector representing the speaker's utterance characteristics.

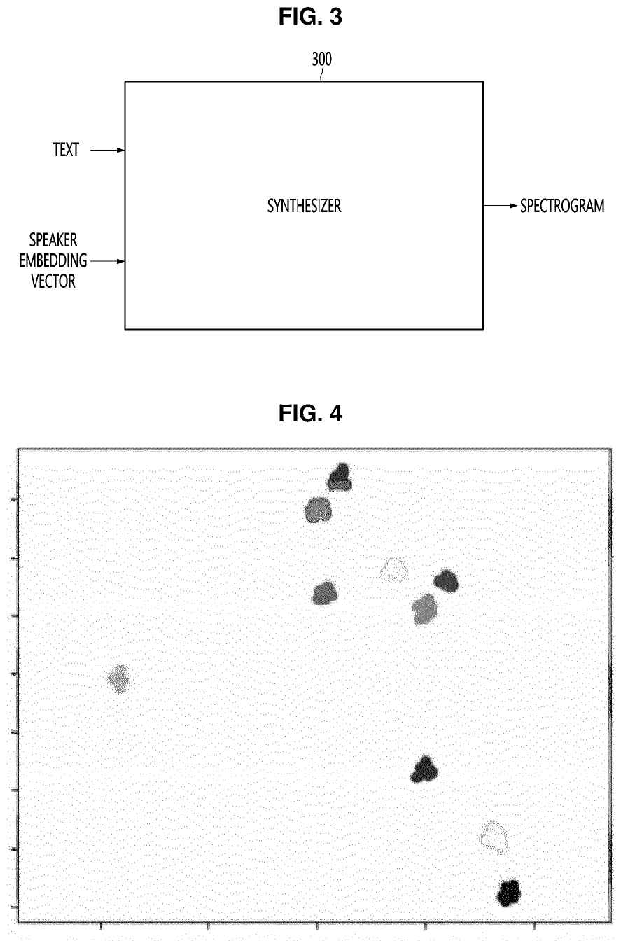

FIG. 3 is a block diagram illustrating an embodiment of a synthesizer of a speech synthesis system. A synthesizer 300 of FIG. 3 may be the same as the synthesizer 220 of FIG. 2.

Referring to FIG. 3, the synthesizer 300 of the speech synthesis system 200 may include a text encoder and a decoder. Meanwhile, it is obvious to one of ordinary skill in the art that the synthesizer 300 may further include other general-purpose elements, in addition to the elements illustrated in FIG. 3.

An embedding vector representing utterance characteristics of a speaker may be generated by the speaker encoder 210 as described above, and the text encoder or the decoder of the synthesizer 300 may receive, from the speaker encoder 210, the embedding vector representing the speaker's utterance characteristics.

For example, the speaker encoder 210 may output an embedding vector of speech data that is most similar to a speech signal or speech sample of the speaker, by inputting the speaker's speech signal or speech sample into a trained artificial neural network model.

FIG. 4 is a diagram illustrating an embodiment of a vector space for generating an embedding vector by a speaker encoder.

According to an embodiment, the speaker encoder 210 may generate first spectrograms by performing short-time Fourier transform (STFT) on a speaker's speech signal or speech sample. The speaker encoder 210 may generate a speaker embedding vector by inputting the first spectrograms into a trained artificial neural network model.

A spectrogram refers to a spectrum of a speech signal that is visualized, and represented via a graph. The x-axis of the spectrogram represents a time, the y-axis of the spectrogram represents a frequency, and a value of a frequency per time may be expressed as a color according to the magnitude of the value. The spectrogram may be a result obtained by performing short-time Fourier transform (STFT) on a speech signal that is continuously given.

STFT refers to a method of splitting a speech signal into sections having a certain length and applying Fourier transform to each section. Here, the result obtained by performing STFT on the speech signal is a complex value, and thus, a spectrogram including only magnitude information may be generated by taking an absolute value to the complex value and losing phase information.

Meanwhile, a Mel spectrogram is generated by readjusting frequency intervals of a spectrogram by a Mel scale. A human auditory organ is more sensitive in a low frequency band than in a high frequency band, and the Mel scale expresses, by reflecting such a characteristic, the relationship between a physical frequency and a frequency perceived actually by a human. A Mel spectrogram may be generated by applying, to a spectrogram, a filter bank based on a Mel scale.

The speaker encoder 210 may display, on a vector space, spectrograms corresponding to various types of speech data and embedding vectors corresponding thereto. The speaker encoder 210 may input, into the trained artificial neural network model, spectrograms that are generated from the speaker's speech signal or speech sample. The speaker encoder 210 may output, from the trained artificial neural network model on the vector space, an embedding vector of speech data, which is most similar to the speaker's speech signal or speech sample, as a speaker embedding vector. In other words, the trained artificial neural network model may receive spectrograms as inputs and generate an embedding vector matching a particular point in the vector space.

Referring to FIG. 3 again, the text encoder of the synthesizer 300 may generate a text embedding vector by receiving text as an input. The text may include a sequence of characters in a particular natural language. For example, the sequence of characters may include alphabetic letters, numbers, punctuation marks, or other special characters.

The text encoder may divide the input text into consonant and vowel units, character units, or phoneme units, and may input the divided text into the artificial neural network model. For example, the text encoder may generate a text embedding vector based on at least one or a combination of two or more of various types of artificial neural network models, such as a pre-net, a CBHG module, a DNN, a CNN, an RNN, an LSTM, and a BRDNN.

Alternatively, the text encoder may divide the input text into a plurality of pieces of short text and generate a plurality of text embedding vectors for each of the pieces of short text.

The decoder of the synthesizer 300 may receive, as inputs, a speaker embedding vector and a text embedding vector from the speaker encoder 210. Alternatively, the decoder of the synthesizer 300 may receive, as an input, a speaker embedding vector from the speaker encoder 210, and may receive, as an input, a text embedding vector from the text encoder.

The decoder may generate a spectrogram corresponding to the input text by inputting the speaker embedding vector and the text embedding vector into the artificial neural network model. In other words, the decoder may generate a spectrogram of the input text in which the speaker's utterance characteristics are reflected. For example, a spectrogram may correspond to a Mel spectrogram, but is not limited thereto.

Meanwhile, although not shown in FIG. 3, the synthesizer 300 may further include an attention module for generating an attention alignment. The attention module refers to a module that learns about an output from among outputs of all time steps of an encoder, which is most related to an output of a particular time step of the decoder. A higher quality spectrogram or Mel spectrogram may be output by using the attention module.

Referring to FIG. 2 again, the vocoder 230 of the speech synthesis system 200 may generate, as actual speech, a spectrogram output from the synthesizer 220. As described above, the output spectrogram may be a Mel spectrogram.

In an embodiment, the vocoder 230 may generate, as an actual speech signal, the spectrogram output from the synthesizer 220 by using inverse short-time Fourier transform (ISFT). A spectrogram or Mel spectrogram does not include phase information, and thus, the phase information of the spectrogram or Mel spectrogram is not considered when generating a speech signal by using ISFT.

In another embodiment, the vocoder 230 may generate, as an actual speech signal, the spectrogram output from the synthesizer 220 by using a Griffin-Lim algorithm. The Griffin-Lim algorithm is an algorithm for estimating phase information from magnitude information of a spectrogram or Mel spectrogram.

Alternatively, the vocoder 230 may generate, as an actual speech signal, the spectrogram output from the synthesizer 220, for example, based on a neural vocoder.

The neural vocoder refers to an artificial neural network model that generates a speech signal by receiving a spectrogram or Mel spectrogram as an input. The neural vocoder may learn, via a large amount of data, the relationship between the spectrogram or Mel spectrogram and the speech signal, and may generate a high-quality actual speech signal via the same.

The neural vocoder may correspond to a vocoder based on an artificial neural network model, such as a WaveNet, a parallel WaveNet, a WaveRNN, WaveGlow, or MeIGAN, but is not limited thereto.

For example, the WaveNet vocoder refers to an autoregressive model that includes several dilated causal convolution layers and uses sequential features between speech samples. The WaveRNN vocoder refers to an autoregressive model in which several dilated causal convolution layers of the WaveNet are replaced with a gated recurrent unit (GRU). The WaveGlow vocoder may be trained to obtain a simple distribution, such as a Gaussian distribution, from a spectrogram dataset x by using an invertible transform function. After being trained, the WaveGlow vocoder may output a speech signal from a sample of the Gaussian distribution by using an inverse function of the transform function.

Meanwhile, even when a speech sample of a certain speaker is input into the speech synthesis system 200, generation of speech for input text, in which utterance characteristics of the speaker are reflected, may be significant. Even when a speaker's speech sample which is not learned about is input, the artificial neural network model of the speaker encoder 210 needs to be trained with speech data of various speakers to output, as a speaker embedding vector, an embedding vector of speech data that is most similar to the speaker's speech sample.

For example, training data for training the artificial neural network model of the speaker encoder 210 may correspond to recorded data that is generated by performing recording by a speaker based on a recording script corresponding to particular text. A detailed operation of a speech generation system for generating recorded data for training the artificial neural network model of the speaker encoder 210 will be described below.

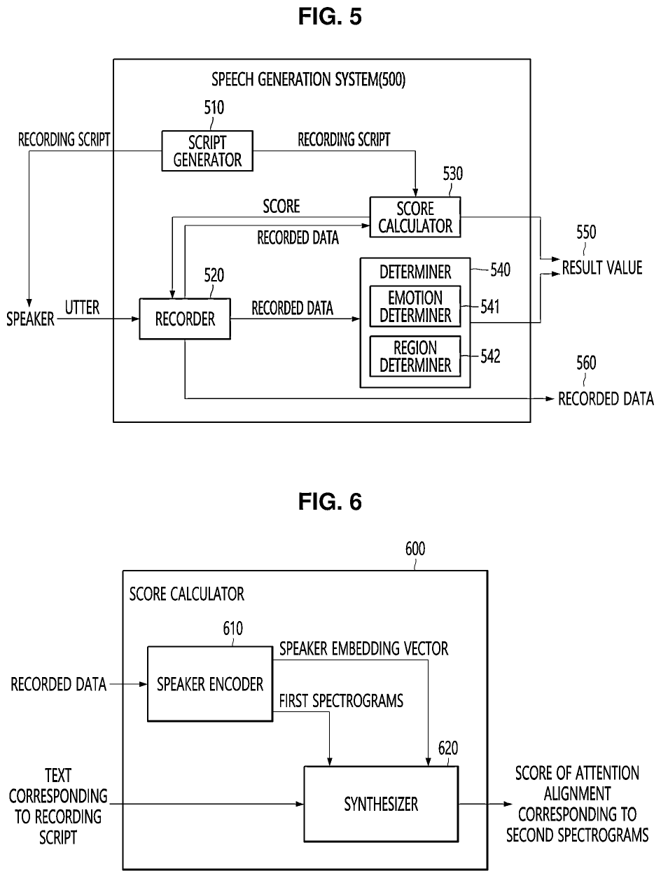

FIG. 5 is a block diagram schematically illustrating an operation of a system for generating speech training data.

Referring to FIG. 5, a system 500 (hereinafter referred to as a speech generation system) for generating speech training data may include a script generator 510, a recorder 520, a score calculator 530, and a determiner 540. Meanwhile, FIG. 5 illustrates that the speech generation system 500 includes only elements related to an embodiment. Accordingly, it is obvious to one of ordinary skill in the art that the speech generation system 500 may further include other general-purpose elements, in addition to the elements illustrated in FIG. 5.

The speech generation system 500 of FIG. 5 may output recorded data 560 by receiving, as an input, speech generated by a speaker's utterance. For example, the speech generation system 500 may output the recorded data 560 by receiving, as an input, speech of a speaker reading a recording script. The output recorded data 560 may be used as training data for training an artificial neural network model.

Meanwhile, the recording script has a probability that a copyright issue may arise when selecting and using previously known materials, and a lot of time and money are consumed when directly generating and using the recording script. Therefore, a recording script needs to be automatically generated through deep learning.

Referring to FIG. 5, the script generator 510 may generate a recording script corresponding to particular text. For example, the script generator 510 may generate the recording script via an algorithm that automatically generates text through deep learning.

The algorithm for automatically generating text in the script generator 510 may be a model that reconstructs data via a recurrent neural network (RNN) having a many-to-one structure and generates text by reflecting context. Alternatively, the algorithm for automatically generating text may be a model that generates text via a long short-term memory (LSTM) or a gated recurrent unit (GRU).

In an embodiment, the script generator 510 may receive a plurality of sentence samples. Also, the script generator 510 may generate the recording script based on the plurality of received sentence samples.

For example, the script generator 510 may receive three sentence samples, “ If there are many sailors the boat goes to the mountains”, “The seasonal pear is delicious”, and “The pregnant woman's belly has noticeably swelled”. In addition, when generating a recording script based on the three sentence samples, the script generator 510 may reconstruct data into pairs of {X, y} to generate 11 learning samples as follows, such that a model may learn about context. Here, y may correspond to a label.

{If there are many, sailors}, {If there are many sailors, the boat}, {If there are many sailors the boat, goes}, {If there are many sailors the boat goes, to the mountains}, {The seasonal, pear}, {The seasonal pear, is delicious}, {The pregnant woman's, belly}, {The pregnant woman's belly, has}, {The pregnant woman's belly has, noticeably}, {The pregnant woman's belly has noticeably, swelled}. For reference, in Korean, pear, belly, and ship are homonyms with the pronunciation of “bae”. The above description corresponds to the description of the Korean language.

In an embodiment, the script generator 510 may design a model by arranging neurons corresponding to the magnitude of a word set by using a fully connected layer as an output layer by using an RNN for learning samples. The model mentioned above may be a model that performs a multi-class classification problem, and may use a softmax function as an activation function and a cross-entropy function as a loss function.

The script generator 510 may automatically generate a recording script via a function of generating a sentence by predicting a next word from an input word. Here, the script generator 510 does not learn about words appearing after “to the mountains”, “delicious”, and “swelled” and thus, may carry out random prediction when “to the mountains”, “delicious”, and “swelled” is input.

A recording script generated by the script generator 510 may be transmitted to a speaker or transmitted as an input to the score calculator 530, which will be described later, to be used to evaluate quality of recorded data.

Meanwhile, when a speaker performs recording based on a received recording script, in the related arts, the speaker generates recorded data by directly carrying out an input, such as “recording”, to a recording apparatus before starting recording, and an input, such as “recording end”, after recording ends, or the speaker generates final recorded data by reading a plurality of sentences of the recording script, generating recorded data for the plurality of sentences, and then editing each of the plurality of sentences by post-processing work. In the former case, recording work is cumbersome, and in the latter case, the post-processing editing process consumes a lot of time.

Accordingly, the speech generation system 500 needs to automatically generate recorded data by detecting a speaker's utterance duration to significantly reduce the inconvenience of the speaker's recording work and shorten time.

The recorder 520 may output recorded data by receiving, as an input, speech generated by performing recording by a speaker based on a recording script. Alternatively, the recorder 520 may output a spectrogram by receiving, as an input, speech generated by performing recording by a speaker based on a recording script. Although not shown in FIG. 5, the recorder 520 may include a speech detector (not shown) and/or a synthesizer (not shown).

For example, a recording script may correspond to “Turn on the set-top box and say it again”, and a speaker may generate recorded data by uttering particular text corresponding to the recording script. Here, the recorded data may be speech data that accurately utters “Turn on the set-top box and say it again” to match the recording script, but may also correspond to speech data that utters “Turn on or off the set-top box and say it again” that does not match the recording script.

In an embodiment, the speech detector (not shown) of the recorder 520 may detect an utterance duration corresponding to a duration for which a speaker actually utters. For example, the speech detector (not shown) may set, as a start point, a point at which an amplitude of a speaker's speech increases to be greater than or equal to a preset reference, may set, as an end point, a point at which the amplitude decreases to be less than or equal to the preset reference and continues for a certain time, and may determine, as an utterance duration, from the start point to the end point.

In detail, the synthesizer (not shown) of the recorder 520 may generate an original spectrogram corresponding to original speech data including a duration for which a speaker actually utters and a silent duration. Here, the synthesizer (not shown) may perform the same function as the synthesizer 220 of FIG. 2 or the synthesizer 300 of FIG. 3. Therefore, the same description thereof as the above description will be omitted.

Thereafter, the synthesizer (not shown) may generate a volume graph by calculating average energy of frames included in the original spectrogram.

The synthesizer (not shown) may determine, as an utterance start point, a point at which a volume value increases to be greater than or equal to a preset first threshold value from among a plurality of frames. In addition, when a duration, for which a volume value is less than or equal to a preset second threshold value from among the plurality of frames, continues for a certain time, the synthesizer (not shown) may determine the corresponding duration as a silent duration, and may determine a start point of the silent duration as an utterance end point. Also, the synthesizer (not shown) may determine, as an utterance duration, a duration between the utterance start point and the utterance end point.

The recorder 520 may generate recorded data by automatically storing only the utterance durations detected by the synthesizer (not shown) and the speech detector (not shown). The recorded data generated by the recorder 520 may be stored in an audio file format, for example, in an audio file format such as AAC, AIFF, DSD, FLAC, MP3, MQA, OGG, WAV, or WMA Lossless.

Thereafter, the recorder 520 may output the generated recorded data 560. Alternatively, the recorder 520 may transmit, to the score calculator 530 and/or the determiner 540, the original spectrogram that is output from the synthesizer (not shown).

The recorded data 560 generated by the recorder 520 is training data for training an artificial neural network model, and thus, quality of the recorded data 560 needs to be evaluated. For example, quality of recorded data may be evaluated in relation to whether or not a speaker performs recording to match a recording script. A score calculator, which will be described below, may be used to evaluate whether or not a speaker performs recording to match a recording script.

FIG. 6 is a block diagram illustrating an embodiment of evaluating quality of recording by using a score calculator.

A score calculator 600 may include a speaker encoder 610 and a synthesizer 620.

The score calculator 600 of FIG. 6 may be the same as the speech synthesis system 100 of FIG. 1 or the speech synthesis system 200 of FIG. 2. Alternatively, the score calculator 600 may be the same as the score calculator 530 of FIG. 5. The speaker encoder 610 of FIG. 6 may perform the same function as the speaker encoder 210 of FIG. 2, and the synthesizer 620 of FIG. 6 may perform the same function as the synthesizer 220 of FIG. 2 or the synthesizer 300 of FIG. 3.

Referring to FIG. 6, the score calculator 600 may calculate a score corresponding to recorded data, based on a recording script generated by the script generator 510 and the recorded data generated by the recorder 520.

In an embodiment, the score calculator 600 may receive recorded data. Also, the score calculator 600 may generate first spectrograms and a speaker embedding vector based on the recorded data. The score calculator 600 may generate second spectrograms corresponding to the recording script, based on the speaker embedding vector and the first spectrograms, and may calculate a score of an attention alignment corresponding to the second spectrograms. Finally, the score calculator 600 may evaluate, based on the score, quality of the recorded data indicating whether or not a speaker performs recording to match the recording script.

Referring to FIG. 6, the speaker encoder 610 of the score calculator 600 may receive recorded data. The speaker encoder 610 may generate first spectrograms by performing STFT on the recorded data.

The speaker encoder 610 may output a speaker embedding vector having a numerical value close to an embedding vector of speech data that is most similar to the recorded data, by inputting the first spectrograms into a trained artificial neural network model.

The synthesizer 620 of the score calculator 600 may receive text corresponding to a recording script. For example, the synthesizer 620 may receive text “Turn on the set-top box and say it again” from a script generator. Also, the synthesizer 620 may receive the first spectrograms and the speaker embedding vector from the speaker encoder 610. The synthesizer 620 may generate second spectrograms corresponding to the received text, based on the first spectrograms and the speaker embedding vector. Finally, the synthesizer 620 may generate an attention alignment corresponding to the second spectrograms, and may evaluate whether or not a speaker performs recording to match the recording script, by calculating a score of the attention alignment.

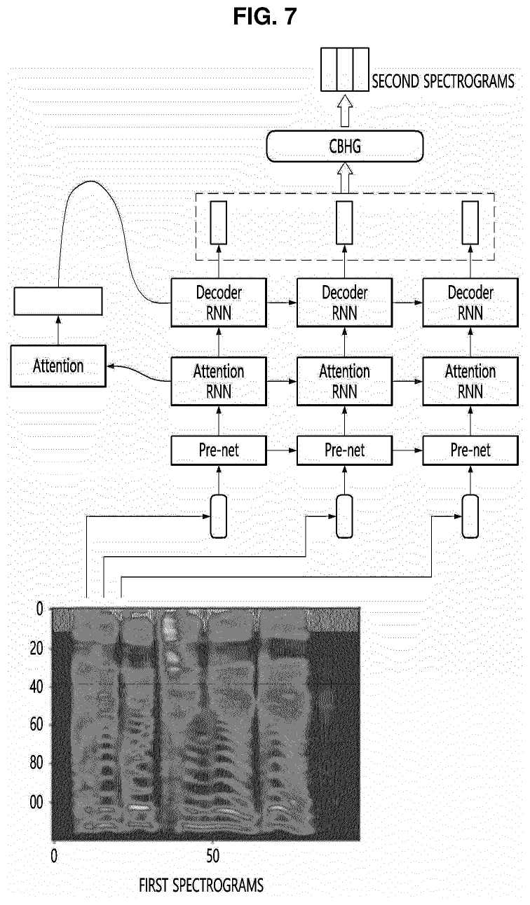

FIG. 7 is a diagram illustrating an embodiment in which a synthesizer generates second spectrograms based on first spectrograms.

In detail, FIG. 7 illustrates an embodiment in which a decoder included in the synthesizer 620 generates second spectrograms based on first spectrograms.

According to an embodiment, the synthesizer 620 may input first spectrograms, which are generated by the speaker encoder 610, to respective time steps of the decoder included in the synthesizer 620 that generates second spectrograms. The synthesizer 620 may generate second spectrograms as a result of inferring respective phonemes corresponding to a recording script, based on first spectrograms.

For example, while the decoder of the synthesizer 620 infers respective phonemes corresponding to an input recording script, a first spectrogram corresponding to each time step may be input as a target spectrogram or a correct answer spectrogram. In other words, the synthesizer 620 may infer respective phonemes corresponding to an input recording script by using a teacher-forcing method of inputting a target spectrogram or a correct answer spectrogram at each decoder step, rather than a method of inputting a value predicted by a t-1^{st} decoder cell into a t^{th} decoder cell.

According to the teacher-forcing method described above, even when the t-1^{st} decoder cell predicts an incorrect result, the tth decoder cell may perform accurate prediction due to the presence of the target spectrogram or the correct answer spectrogram.

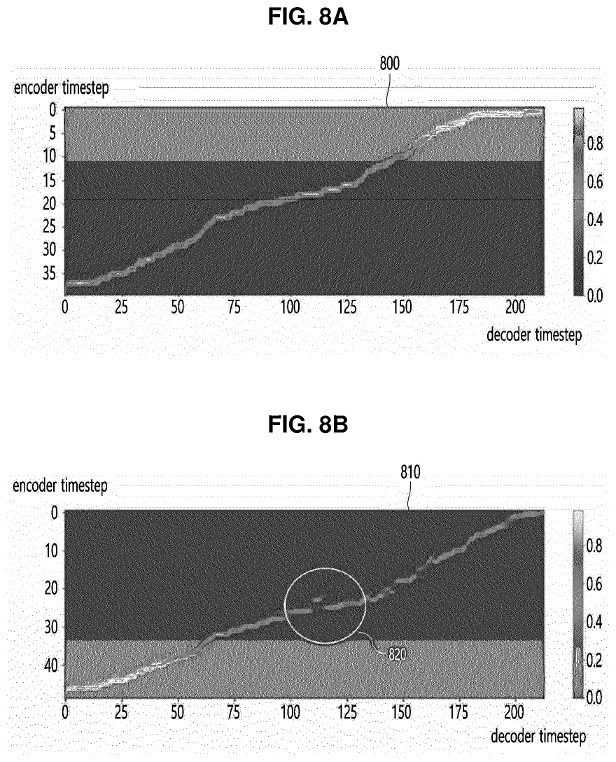

FIGS. 8A and 8B are diagrams illustrating quality of an attention alignment corresponding to second spectrograms. FIGS. 8A and 8B illustrate examples of an attention alignment generated by the synthesizer 620 of the score calculator 600 in correspondence to second spectrograms.

For example, an attention alignment may be represented on two-dimensional coordinates, the horizontal axis of the two-dimensional coordinates indicates time steps of a decoder included in the synthesizer 620, and the vertical axis indicates time steps of an encoder included in the synthesizer 620. In other words, the two-dimensional coordinates on which the attention alignment is expressed indicate which portion the synthesizer 620 may concentrate on when generating a spectrogram.

The decoder time steps refer to a time invested by the synthesizer 620 to utter respective phonemes corresponding to a recording script. The decoder time steps are arranged at time intervals corresponding to a single hop size, and the single hop size may correspond to, for example, 1/80 second, but is not limited thereto.

The encoder time steps correspond to the phonemes included in the recording script. For example, when input text is “Turn on the set-top box and say it again”, the encoder time steps may include “T”, “u”, “r”, “n”, “ ”, “o”, “n”, “ ”, “t”, “h”, “e”, “ ”, “s”, “e”, “t”, . . . (hereinafter omitted).

In addition, each of points constituting the attention alignment is expressed in a particular color. Here, the color may be matched to a particular value corresponding thereto. For example, each of colors constituting an attention alignment may be a value representing a probability distribution, and may be a value between 0 and 1.

For example, when a line indicating an attention alignment is dark and noise is low, the synthesizer 620 may certainly perform inference at every moment when generating a spectrogram. In other words, in the example described above, the synthesizer 620 may generate a high-quality Mel spectrogram. Therefore, quality of an attention alignment (e.g., the degree to which a color of the attention alignment is dark, the degree to which a contour of the attention alignment is clear, and the like) may be used as a highly significant index to estimate inference quality of the synthesizer 620.

Referring to FIG. 8A, an attention alignment 800 includes a dark line and low noise, and thus, the synthesizer 620 may certainly perform inference at every moment when generating a spectrogram. For example, the attention alignment 800 of FIG. 8A may correspond to an attention alignment that is generated from a recording script “Turn on the set-top box and say it again” by inputting recorded data that is generated by relatively accurately uttering “Turn on the set-top box and say it again” by a speaker based on the recording script “Turn on the set-top box and say it again” to match the recording script.

On the contrary, referring to FIG. 8B, an attention alignment 810 has a middle portion 820 in which a line is not clear, and the middle portion 820 includes an unclear portion. Therefore, quality of a Mel spectrogram may not be significantly high. For example, the attention alignment 800 of FIG. 8B may correspond to an attention alignment that is generated from a recording script “Turn on the set-top box and say it again” by inputting recorded data that is generated by uttering “Turn on or off the set-top box and say it again” by a speaker based on the recording script “Turn on the set-top box and say it again” not to match the recording script.

In other words, “Turn on” is common text between recorded data and input text, and thus, an attention alignment is drawn well. However, after that, the attention alignment may not be drawn well at a portion “or off” that does not match between the recorded data and an input recording script. Accordingly, after “Turn on”, a spectrogram corresponding to “the” may be input into a decoder cell. However, as a spectrogram with the pronunciation of “or” is input, the synthesizer 620 may concentrate on a wrong portion.

As described above, when recorded data, which is generated by performing recording by a speaker not to match a recording script, is input, quality of an attention alignment that is output may be poor. The quality of the attention alignment may be evaluated based on a score of the attention alignment. When the quality of the attention alignment is determined to be poor, recording may be determined to be performed not to match a recording script.

For example, the score calculator 600 may calculate an encoder score, a decoder score, a concentration score, or a step score of an attention alignment to evaluate quality of the attention alignment.

The score calculator 600 may output any one of the encoder score, the decoder score, the concentration score, and the step score as a final score for evaluating the quality of the attention alignment.

Alternatively, the score calculator 600 may output, as a final score for evaluating the quality of the attention alignment, a value obtained by combining at least one of the encoder score, the decoder score, the concentration score, and the step score.

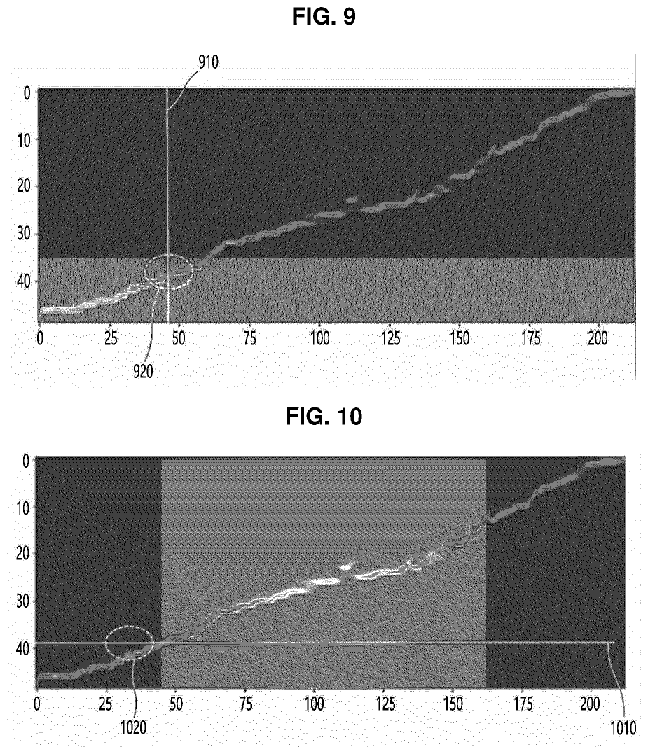

FIG. 9 is a diagram illustrating an embodiment in which a score calculator calculates an encoder score.

Referring to FIG. 9, values 910 corresponding to a decoder time step 50 in an attention alignment are indicated. The attention alignment is transposed by recording each softmax result value, and thus, 1 is obtained by adding up all values corresponding to a single step constituting a decoder time step. In other words, when all of the values 910 of FIG. 9 are added up, 1 is obtained.

Meanwhile, a upper values 920 from among the values 910 of FIG. 9 may enable a determination of which phoneme the synthesizer 620 of the score calculator 600 concentrates on at a time point corresponding to the decoder time step 50 to generate a spectrogram. Therefore, the score calculator 600 may identify whether or not a spectrogram appropriately represents input text (i.e., quality of the spectrogram) by calculating an encoder score for each of steps constituting a decoder time step.

For example, the score calculator 600 may calculate, as in Equation 1 below, an encoder score at an s^{th} step, based on a decoder time step.

$$\begin{matrix}{encoder\_score}_{s} = {\sum }_{i = 1}^{n} max ( \text{?} ) & [ Equation 1 ]\end{matrix}$$

$$\text{?} \text{indicates text missing or illegible when filed}$$

In Equation 1, max(align_{decoder}, s, i) indicates an i^{th} upper value of the s^{th} step based on the decoder time step in the attention alignment (wherein s and i are natural numbers greater than or equal to 1).

In other words, the score calculator 600 extracts n values from among values at the s^{th} step of the decoder time step (wherein n is a natural number greater than or equal to 2). Here, the n values may refer to n upper values at the s^{th} step.

In addition, the score calculator 600 calculates an s^{th} score (encoder_score,) at the s^{th} step by using the extracted n values. For example, the score calculator 600 may calculate the s^{th} score (encoder_score,) by adding the extracted n values.

A final encoder score (encoder_score) may be calculated as in Equation 2 below, based on encoder scores that are respectively calculated for all decoder time steps of the attention alignment.

$$\begin{matrix}encoder\_score = \text{?} & [ Equation 2 ]\end{matrix}$$

$$\text{?} \text{indicates text missing or illegible when filed}$$

In Equation 2, de₁ corresponds to the x-axis length (a frame length) of a spectrogram, and s corresponds to an index of a decoder time step. Other variables constituting Equation 2 are the same as described in Equation 1.

FIG. 10 is a diagram illustrating an embodiment in which a score calculator calculates a decoder score.

Referring to FIG. 10, values 1010 corresponding to an encoder time step 40 in an attention alignment are indicated. Also, b upper values 1020 from among the values 1010 are indicated.

As described above with reference to FIG. 9, an encoder score is calculated with values at each of steps constituting a decoder time step. On the contrary, a decoder score is calculated with values at each of steps constituting an encoder time step. The encoder score and the decoder score have different aims. In detail, the encoder score is an index for determining whether or not an attention module determines well, every hour, a phoneme to be concentrated on. On the contrary, the decoder score is an index for determining whether or not the attention module concentrates well on a particular phoneme constituting input text without omitting time allocation.

For example, the score calculator 600 may calculate, as in Equation 3 below, a decoder score at an s^{th} step based on an encoder time step.

$$\begin{matrix}{decoder\_score}_{s} = \text{?} & [ Equation 3 ]\end{matrix}$$

$$\text{?} \text{indicates text missing or illegible when filed}$$

In Equation 3, max(algin_{encoder}, s, i) indicates an i^{th} upper value of the s^{th} step based on the encoder time step in the attention alignment (wherein s and i are natural numbers greater than or equal to 1).

In other words, the score calculator 600 extracts m values from among values at the s^{th} step of the encoder time step (wherein m is a natural number greater than or equal to 2). Here, the m values may refer to m upper values at the s^{th} step.

In addition, the score calculator 600 calculates an s^{th} score (decoder_score,) at the s^{th} step by using the extracted m values. For example, the score calculator 600 may calculate the s^{th} score (decoder_score,) by adding up the extracted m values.

A final decoder score (decoder_score) may be calculated as in Equation 4 below, based on decoder scores that are respectively calculated for all encoder time steps of the attention alignment.

$$\begin{matrix}decoder\_score = \text{?} min ) ( ln ( \text{?} max ( \text{?} ) & [ Equation 4 ]\end{matrix}$$

$$\text{?} \text{indicates text missing or illegible when filed}$$

In Equation 4, min((x), y)indicates an y^{th} small value (i.e., a lower y^{th} value) from among values constituting a set x, and en₁ indicates an encoder time step. dl indicates a length of a decoder score, and becomes a value obtained by adding up to a lower dl^{th} value.

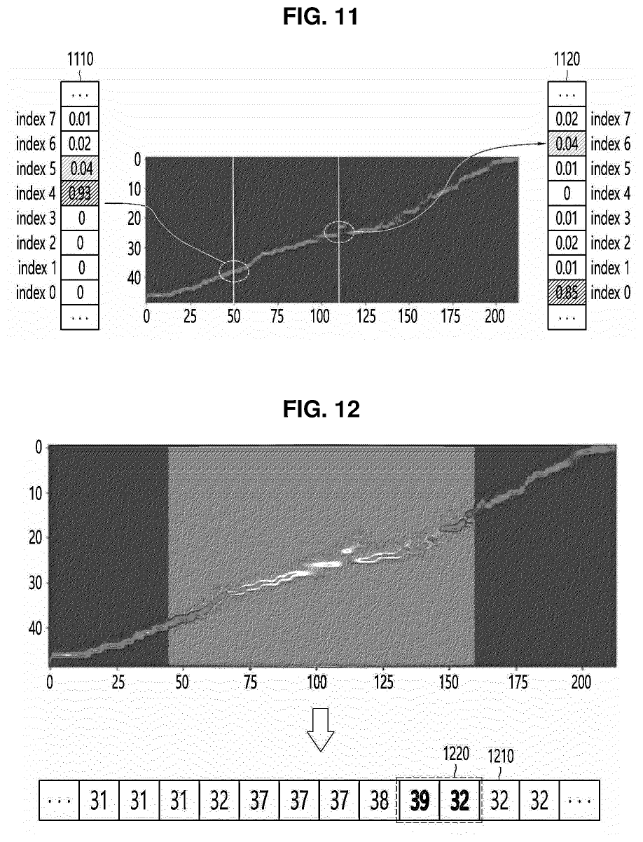

FIG. 11 is a diagram illustrating an embodiment in which a score calculator calculates a concentration score.

According to an embodiment, the score calculator 600 may derive a first value that is first largest and a second value that is second largest, from among values corresponding to a first time step from among time steps of a decoder. The score calculator 600 may calculate a concentration score by using a difference value between a first index value indicating an encoder time step corresponding to the first value and a second index value indicating an encoder time step corresponding to the second value.

With respect to a determination of quality of an attention alignment, when the synthesizer 620 incorrectly concentrates on a certain phoneme, a difference may occur between an incorrectly concentrated portion and a portion to which the synthesizer 620 returns to concentrate on a correct phoneme again. Accordingly, in the attention alignment, a great difference may occur between an index indicating an encoder time step corresponding to a first largest value from among values corresponding to a particular decoder time step and an index indicating an encoder time step corresponding to a second largest value. The great difference may indicate a high probability that a speaker performs recording not to match text corresponding to a recording script.

For example, the score calculator 600 may calculate, as in Equation 5 below, a concentration score at an s^{th} step based on a decoder time step.

concentration_score,=−(sort_diff(align_{decoder}, s, 1, 2)−1)² [Equation 5]

In Equation 5, s may correspond to an index of the decoder time step, and sort_diff(align_{decoder}, s, 1, 2) may correspond to a difference value between a first index value indicating an encoder time step corresponding a first value that is first largest from among values corresponding to the s^{th} step based on the decoder time step and a second index value indicating an encoder time step corresponding to a second value that is second largest. For example, when a difference between a first index and a second index is 1, a value of a concentration score becomes 0. However, when the difference between the first index and the second index is greater than or equal to 2, the value of the concentration score has a negative value. Therefore, an increase in the value of the concentration score may indicate that a speaker performs recording to match text corresponding to a recording script.

For example, referring to FIG. 11, values 1110 corresponding to a decoder time step 50 are indicated. An index of an encoder time step corresponding to a first largest value from among the values 1110 corresponding to the decoder time step 50 is 4, and an index of an encoder time step corresponding to a second largest value is 5. Therefore, a concentration score at the decoder time step 50 is 0. On the contrary, an index of an encoder time step corresponding to a first largest value from among values 1120 corresponding to a decoder time step 110 is 0, and an index of an encoder time step corresponding to a second largest value is 6. Therefore, a concentration score at the decoder time step 110 is −25. Unlike at the decoder time step 50, an attention alignment at the decoder time step 110 includes an unclear portion.

A final concentration score (concentration_score) may be calculated as in Equation 6 below, based on concentration scores that are respectively calculated for all decoder time steps of the attention alignment.

$$concentration\_score = - \text{?} {( sort\_ diff ( \text{?} , s , 1 , 2 ) - 1 )}^{2} \\ \text{?} \text{indicates text missing or illegible when filed} \qquad [ Equation 6 ]$$

In Equation 6, dl may correspond to the x-axis length (a frame length) of a spectrogram, and other variables constituting Equation 6 are the same as described in Equation 5.

FIG. 12 is a diagram illustrating an embodiment in which a score calculator calculates a step score.

According to an embodiment, the score calculator 600 may derive a first maximum value from among values corresponding to a first time step from among decoder time steps, and may derive a second maximum value from among values corresponding to a second time step corresponding to a next step of the first time step. The score calculator 600 may compare a first index value indicating an encoder time step corresponding to the first maximum value and a second index value indicating an encoder time step corresponding to the second maximum value. When the first index value is greater than the second index value, the score calculator 600 may calculate a step score based on a difference value between the first index value and the second index value.

For example, even when the synthesizer 620 mistakes a particular spectrogram for a phoneme that is not a correct answer, a correct answer spectrogram may be input by a teacher-forcing method, and thus, the synthesizer 620 may re-concentrate on a phoneme that is a correct answer. In this case, an attention alignment may show a reverse pattern in which an index value indicating an encoder time step corresponding to the maximum value from among values corresponding to a particular decoder time step becomes greater than an index value indicating an encoder time step corresponding to the maximum value from among values corresponding to a next time step of the particular decoder time step.

Accordingly, in the attention alignment, a great difference may occur between an index indicating an encoder time step corresponding to the maximum value from among values corresponding to a particular decoder time step and an index indicating an encoder time step corresponding to the maximum value from among values corresponding to a next time step of the particular decoder time step. The great difference may indicate a high probability that a speaker performs recording not to match text corresponding to a recording script.

For example, the score calculator 600 may calculate, as in Equation 7 below, a step score at an s^{th} step based on a decoder time step.

step_scoreₛ=−step(align_{decoder}, s, s−1) [Equation 7]

In Equation 7, s may correspond to an index of a decoder time step, and step(align_{decoder}, s, s−1) may correspond to a difference value between a first index value and a second index value when the first index value is greater than the second index value as a result of comparing the first index value indicating an encoder time step corresponding to the maximum value from among values corresponding to an s-^{st} step based on the decoder time step and the second index value indicating an encoder time step corresponding to the maximum value from among values corresponding to the sth step. When the first index value is less than or equal to the second index value, step(align_{decoder}, s, s−1) may correspond to 0. Therefore, an increase in a step score may indicate that a speaker performs recording to match a recording script.

For example, FIG. 12 illustrates indexes 1210 indicating an encoder time step corresponding to the maximum value from among values corresponding to each of decoder time steps in the attention alignment. As an index of a decoder time step increases, a value of an index of an encoder time step corresponding to the maximum value also mostly increases. However, the attention alignment may include a reverse duration 1220 in which an index value indicating an encoder time step corresponding to the maximum value from among values corresponding to a particular decoder time step becomes greater than an index value of an encoder time step corresponding to the maximum value from among values corresponding to a next time step. In a duration other than the reverse duration 1220, a value of a step score is 0, but in the reverse duration 1220, the step score has a negative value.

A final step score (step_score) may be calculated as in Equation 8 below, based on step scores that are respectively calculated for all decoder time steps of the attention alignment.

$$step\_score = - {\sum }_{\text{?} = 1}^{\text{?}} step ( {align}_{\text{?}} , \text{?} , \text{?} - 1 )$$

$$\text{?} \text{indicates text missing or illegible when filed}$$

In Equation 8, corresponds to the x-axis length (a frame length) of a spectrogram, and other variables constituting Equation 8 are the same as described in Equation 7.

In summary, the score calculator 600 may output, as a final score for evaluating quality of an attention alignment, any one of an encoder score, a decoder score, a concentration score, and a step score as described above with reference to FIGS. 9 to 12.

Alternatively, the score calculator 600 may output, as a final score for evaluating quality of an attention alignment, a value obtained by combining at least one of an encoder score, a decoder score, a concentration score, and a step score as described above with reference to FIGS. 9 to 12. For example, record_score, which is a final score for evaluating quality of an attention alignment, may be calculated as in Equation 9 below.

record_score=α×encoder_score+β×decoder_score +γ×concentrration_score+δ×step_score [Equation 9]

In Equation 9, an encoder score encoder_score may be calculated according to Equation 2 described above, and a decoder score decoder_score may be calculated according to Equation 4 described above. Also, a concentration score, concentration_score may be calculated according to Equation 6 described above, and a step score step_score may be calculated according to Equation 8 described above. In addition, α, β, γ and δ, and may each correspond to any positive real number.

Referring to FIG. 5 again, the score calculator 530 may compare a score output by the synthesizer (not shown) with a preset value (a threshold value). Alternatively, the score calculator 530 may output the score, which is output by the synthesizer (not shown), as a result value 550 of the speech generation system 500.

Also, the score calculator 530 may evaluate, according to the result of the comparison, quality of recorded data indicating whether or not a speaker performs recording to match a recording script. For example, when the score is less than the threshold value, the score calculator 530 may evaluate that the speaker performs recording not to match text corresponding to the recording script.

Similarly, the score calculator 530 may compare a final score with a preset value (a threshold value), and, when the final score is less than the threshold value, may evaluate that the speaker performs recording not to match the recording script.

The recorder 520 may determine whether or not to regenerate recorded data by receiving, as an input, a score output by the score calculator 530. In detail, the recorder 520 may determine whether or not to regenerate recorded data, based on whether or not quality of the recorded data satisfies a certain criterion.

For example, as described above, the recorder 520 may generate recorded data by automatically storing only utterance durations detected by the synthesizer (not shown) and the speech detector (not shown). Here, when quality of generated recorded data does not satisfy a certain criterion, the recorder 520 may determine to regenerate recorded data, and may receive again, as an input, a speaker's speech based on the same recording script without storing recorded data corresponding to a corresponding utterance duration. In contrast, when the quality of the generated recorded data satisfies the certain criterion, the recorder 520 may determine not to regenerate recorded data, and may intactly store and output recorded data corresponding to an utterance duration.

As described above, as the score calculator 530 transmits, to the recorder 520, a result of evaluating quality of recorded data, such that the recorder 520 may determine whether or not to regenerate recorded data, the speech generation system 500 may determine whether or not to perform re-recording even without directly hearing and determining whether or not a speaker performs recording well, thereby significantly increasing the convenience of recording work.

The speech generation system 500 may output the result value 550 of labeling corresponding to recorded data by receiving, as an input, a speaker's speech based on a recording script. Alternatively, the determiner 540 may output the result value 550 of labeling for recorded data by receiving, as an input, recorded data generated by performing recording by a speaker based on a recording script.

Recorded data is training data for training an artificial neural network model, and thus, each label corresponding to a labeling result value may be useful when conducting research on emotions, dialects, and the like included in speech.

The determiner 540 may include an emotion determiner 541 and a region determiner 542.

The emotion determiner 541 may receive recorded data as an input, determine any one of a plurality of emotions, and output the result value 550 of emotion labeling. For example, the plurality of emotions may include normal, happiness, sadness, anger, surprise, disgust, fear, and the like.

The region determiner 542 may receive recorded data as an input, determine any one of a plurality of regions, and output the result value 550 of region labeling. In other words, the region determiner 542 may determine that the recorded data uses the dialect of a particular region and output the corresponding region as a labeling result value. For example, the plurality of regions may include Seoul, Gyeongsang-do, Chungcheong-do, Gangwon-do, Jeolla-do, Jeju-do, North Korea, and the like.

In an embodiment, the determiner 540 may determine an emotion or region through deep learning. For example, the determiner 540 may determine an emotion or region via a model, such as a DNN, a CNN, an LSTM, an RNN, and a CRNN, or a combination of two or more thereof.

A synthesizer (not shown) of the determiner 540 may generate a spectrogram corresponding to recorded data, in particular, a Mel spectrogram, by receiving the recorded data as an input.

In an embodiment, a spectrogram has a characteristic in which the saturation of an emotion is not uniform in each certain frame section, and thus, the emotion determiner 541 may label an emotion by using an LSTM and an attention mechanism to determine emotions in units of certain frame sections. For example, the emotion determiner 541 may calculate a weight for a contribution of an emotion of each frame by the attention mechanism. In detail, the emotion determiner 541 may pass output values of the LSTM by using attention, and may pass the output values through a weighted DNN and softmax to obtain the distribution of an emotion in recorded data and predict an emotion. Accordingly, the emotion determiner 541 may determine and label an emotion.

In an embodiment, the region determiner 542 may generate data for analysis from a spectrogram and vectorize feature values. In addition, the region determiner 542 may calculate a state probability from a feature vector obtained by vectorizing the feature values by applying an artificial intelligence algorithm including deep learning, and may determine and label a region via learned intonation, word, utterance speed, pitch, and the like.

In the embodiments described above, a process of determining an emotion of recorded data by the emotion determiner 541 and a process of determining a region of the recorded data by the region determiner 542 may be applied to various labeling processes of the recorded data, but are not limited thereto.

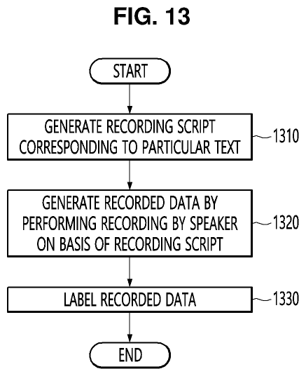

FIG. 13 is a flowchart illustrating an embodiment of a method of generating speech training data.

Referring to FIG. 13, in operation 1310, a system may generate a recording script corresponding to particular text.

In an embodiment, the system may receive a plurality of sentence samples. Also, the system may generate a recording script based on the plurality of sentence samples.

In operation 1320, the system may generate recorded data by performing recording by a speaker based on the recording script.

In an embodiment, the system may detect an utterance duration corresponding to a duration for which the speaker actually utters. Also, the system may generate recorded data by using the utterance duration.

In an embodiment, the system may calculate a score corresponding to the recorded data, based on the recording script and the recorded data. Also, the system may compare the score with a preset value. In addition, the system may evaluate, according to a result of the comparison, quality of the recorded data indicating whether or not the speaker performs recording to match the recording script.

In an embodiment, the system may determine whether or not to regenerate recorded data, based on whether or not the quality of the recorded data satisfies a certain criterion.

In operation 1330, the system may label the recorded data.

In an embodiment, the system may perform one or more of emotion labeling and region labeling of the recorded data.

According to a method of generating speech training data, according to the embodiments described above, the inconvenience of a worker and time consumption may be significantly reduced, and efficiency may be significantly increased by automating a series of processes of generating training data for training an artificial neural network model.

In addition, a method that does not raise a copyright issue in a process of generating training data may be provided.

Effects of embodiments are not limited to the above-mentioned effects, and other effects not mentioned will be clearly understood by one of ordinary skill in the art from the description.

Various embodiments of the present disclosure may be implemented as software (e.g., a program) including one or more instructions stored in a machine-readable storage medium. For example, a processor of a machine may call at least one of the stored one or more instructions from the storage medium and execute the called instruction. Accordingly, the machine may be operated to perform at least one function according to the called at least one instruction. The one or more instructions may include code generated by a compiler or code executable by an interpreter. The machine-readable storage medium may be provided in the form of a non-transitory storage medium. Here, “non-transitory” only indicates that the storage medium is a tangible device and does not include a signal (e.g., an electromagnetic wave), and this term does not distinguish between a case in which data is semi-permanently stored in a storage medium and a case in which data is temporarily stored.

The above detailed description is for illustration, and one of ordinary skill in the art to which the description belongs will understand that the description may be easily modified into other specific forms without changing the technical spirit or essential features of the present disclosure. Therefore, it should be understood that the embodiments described above are illustrative in all respects and not restrictive. For example, each element described as a single type may be implemented in a distributed form, and likewise elements described as being distributed may also be implemented in a combined form.

The scope of the present embodiment is indicated by claims to be described below rather than by the detailed description, and it should be construed to include all changes or modifications derived from the meaning and scope of the claims and their equivalents.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A computer-implemented method of generating speech, the method comprising:
generating, at a processor, a recording script corresponding to particular text;
generating, at the processor, recorded data by performing recording by a speaker based on the recording script; and
labeling, at the processor, the recorded data.

2. The method of claim 1, wherein generating the recording script comprises:
receiving a plurality of sentence samples; and
generating the recording script based on the plurality of sentence samples.

3. The method of claim 1, wherein generating the recorded data comprises:
detecting an utterance duration corresponding to a duration for which the speaker actually utters; and
generating the recorded data by using the utterance duration.

4. The method of claim 1, further comprising:
calculating a score corresponding to the recorded data, based on the recording script and the recorded data;
comparing the score with a preset value; and
evaluating, according to a result of the comparison, quality of the recorded data indicating whether or not the speaker performs recording to match the recording script.

5. The method of claim 4, wherein calculating the score comprises:
generating first spectrograms and a speaker embedding vector, based on the recorded data;
generating second spectrograms corresponding to the recording script, based on the speaker embedding vector and the first spectrograms; and
calculating a score of an attention alignment corresponding to the second spectrograms, wherein generating the second spectrograms comprises:
inputting the first spectrograms to each time step of a decoder included in a synthesizer that generates second spectrograms; and
generating the second spectrograms as a result of inferring respective phonemes corresponding to the recording script, based on the first spectrograms.

6. The method of claim 5, wherein the attention alignment is expressed based on a first axis corresponding to time steps of a decoder included in a synthesizer that generates second spectrograms, and a second axis corresponding to time steps of an encoder included in the synthesizer, and calculating the score comprises:
deriving a first value that is first largest and a second value that is second largest, from among values corresponding to a first time step from among time steps of a decoder; and
calculating the score by using a difference value between a first index value indicating a time step of an encoder corresponding to the first value and a second index value indicating a time step of an encoder corresponding to the second value.

7. The method of claim 5, wherein the attention alignment is expressed based on a first axis corresponding to a time step of a decoder included in a synthesizer that generates second spectrograms, and a second axis corresponding to a time step of an encoder included in the synthesizer, and calculating the score comprises:
deriving a first maximum value from among values corresponding to a first time step from among time steps of the decoder;
deriving a second maximum value from among values corresponding to a second time step corresponding to a next step of the first time step;
comparing a first index value indicating a time step of an encoder corresponding to the first maximum value and a second index value indicating a time step of an encoder corresponding to the second maximum value; and
when the first index value is greater than the second index value, calculating the score based on a difference value between the first index value and the second index value.

8. The method of claim 1, further comprising determining whether or not to regenerate the recorded data, based on whether or not quality of the recorded data satisfies a certain criterion.

9. The method of claim 1, wherein the labeling comprises performing one or more of emotion labeling or region labeling of the recorded data.

10. A non-transitory computer-readable recording medium storing instructions, when executed by one or more processors, configured to perform the method of claim 1.

11. A system comprising:
at least one memory storing instructions; and
at least one processor configured to execute the instructions to:
generate a recording script corresponding to particular text;
generate recorded data by performing recording by a speaker based on the recording script; and
label the recorded data.

12. The system of claim 11, wherein to generate the recording script, the at least one processor is configured to:
receive a plurality of sentence samples; and
generate the recording script based on the plurality of sentence samples.

13. The system of claim 11, wherein to generate the recorded data, the at least one processor is configured to:
detect an utterance duration corresponding to a duration for which the speaker actually utters; and
generate the recorded data by using the utterance duration.

14. The system of claim 11, wherein the at least one processor is further configured to:
calculate a score corresponding to the recorded data, based on the recording script and the recorded data;
compare the score with a preset value; and
evaluate, according to a result of the comparison, quality of the recorded data indicating whether or not the speaker performs recording to match the recording script.

15. The system of claim 14, wherein to calculate the score, the at least one processor is configured to:
generate first spectrograms and a speaker embedding vector, based on the recorded data;
generate second spectrograms corresponding to the recording script, based on the speaker embedding vector and the first spectrograms; and
calculate a score of an attention alignment corresponding to the second spectrograms, wherein to generate the second spectrograms, the at least one processor is configured to:
input the first spectrograms to each time step of a decoder included in a synthesizer that generates second spectrograms; and
generate, based on the first spectrograms, the second spectrograms as a result of inferring respective phonemes corresponding to the recording script.

16. The system of claim 15, wherein the attention alignment is expressed based on a first axis corresponding to time steps of a decoder included in a synthesizer that generates second spectrograms, and a second axis corresponding to time steps of an encoder included in the synthesizer, and to calculate the score, the at least one processor is configured to:
derive a first value that is first largest and a second value that is second largest, from among values corresponding to a first time step from among time steps of a decoder; and
calculate the score by using a difference value between a first index value indicating a time step of an encoder corresponding to the first value and a second index value indicating a time step of an encoder corresponding to the second value.

17. The system of claim 15, wherein the attention alignment is expressed based on a first axis corresponding to a time step of a decoder included in a synthesizer that generates second spectrograms, and a second axis corresponding to a time step of an encoder included in the synthesizer, and to calculate the score, the at least one processor is configured to:
derive a first maximum value from among values corresponding to a first time step from among time steps of the decoder;
derive a second maximum value from among values corresponding to a second time step corresponding to a next step of the first time step;
compare a first index value indicating a time step of an encoder corresponding to the first maximum value and a second index value indicating a time step of an encoder corresponding to the second maximum value; and
when the first index value is greater than the second index value, calculate the score based on a difference value between the first index value and the second index value.

18. The system of claim 11, wherein the at least one processor is further configured to determine whether or not to regenerate the recorded data, based on whether or not quality of the recorded data satisfies a certain criterion.

19. The system of claim 11, wherein the at least one processor is further configured to perform one or more of emotion labeling or region labeling of the recorded data.
